(19) United States
(12) Patent Application Publication
(10) Pub. No.: US 2023/0216435 A1
(43) Pub. Date: Jul. 6, 2023

(54) PIEZOELECTRIC AIRFLOW POWER GENERATOR

(71) Applicant: PIEZOPOWER, LLC, Colorado Springs, CO (US)

(72) Inventor: Jason B. Snyder, Colorado Springs, CO (US)

(73) Assignee: PIEZOPOWER, LLC, Colorado Springs, CO (US)

(21) Appl. No.: 18/149,874

(22) Filed: Jan. 4, 2023

Related U.S. Application Data
(60) Provisional application No. 63/296,255, filed on Jan. 4, 2022.

(51) Int. Cl. H02N 2/18; F04F 5/20

(52) U.S. Cl. CPC H02N 2/185; F04F 5/20

(57) ABSTRACT

Disclosed are devices and methods for generating electrical power by using airflow energy to create air pressure fluctuations within Helmholtz chambers containing piezoelectric materials. The generator device includes an intake having stationary blades for directing wind into a flow treatment stage, which in turn directs a flow of modified air into a flow interface stage. In the flow interface stage, a plurality of Helmholtz chambers containing piezoelectric units are configured around a flow interface chamber wherein passing modified airflow establishes air pressure fluctuations within the Helmholtz chambers thereby causing the piezoelectric units to generate electricity. The device routes generated electrical current to a processor for use as a power source. Also disclosed is a method of generating electrical power using airflow energy. The method includes collecting airflow from the environment to create pressure fluctuations within containers housing piezoelectric units.

### CROSS-REFERENCE TO RELATED APPLICATIONS

This application claims priority to U.S. Provisional Application No. 63/296,255, filed Jan. 4, 2022, which is hereby incorporated by reference herein in its entirety.

### BACKGROUND

### Field of the Invention

The disclosed invention relates to devices, systems, and methods for producing electrical power through use of airflow-generated mechanical stress on piezoelectric materials.

### Relevant Background

Existing systems using piezoelectric materials to generate electrical power from wind or airflow energy suffer serious shortcomings and deficiencies. Namely, some existing systems direct airflow across piezoelectric materials, causing them to vibrate, while others use turbulent airflow to vibrate piezoelectric materials directly or indirectly. Such systems are inefficient because it is difficult or impossible to deliver high energy airflow to a large number of piezoelectric power generation units arranged in series within an airflow. Airflow passing over a first piezoelectric unit necessarily loses energy and will be less efficient at generating electricity as it passes over a second piezoelectric unit, and so on.

Some existing wind power generators also use Helmholtz resonance to generate electricity, but such generators use the resonance to drive mechanical electromagnetic oscillators, not to vibrate piezoelectric materials. Such a use of Helmholtz resonance introduces mechanical inefficiencies that are avoided by use of piezoelectric materials. No known airflow power devices use airflow across Helmholtz chambers to produce air pressure oscillations to activate the piezoelectric materials. Further, existing devices only use unidirectional airflow across Helmholtz chambers to generate electricity. Because the airflow only gets a single pass across a given Helmholtz chamber, such devices are inherently inefficient, and are only able to extract a small proportion of energy out of the incoming airflow.

Therefore, it is apparent that a need exists for a piezoelectric airflow power generator that more efficiently harvests energy from ambient airflow. It is an object of the disclosed invention to improve on known unidirectional piezoelectric airflow power generators by using the incoming airflow energy to create an airflow having a vortex pattern, i.e., a pattern of airflow wherein the air revolves repeatedly around an axis line. By creating a vortex airflow pattern, a greater proportion of the energy taken into the generator can be harvested, since the airflow can be guided past a larger number of Helmholtz chambers, and further can flow across those Helmholtz generators repeatedly before passing out of the device.

These and other deficiencies of the prior art are addressed by one or more embodiments of the disclosed invention. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out hereafter.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures.

FIG. 1 depicts a cross-sectional view of a Helmholtz chamber as used in embodiments of the disclosed invention.

FIG. 2 depicts a cross-sectional view of a Helmholtz chamber as used in embodiments of the disclosed invention.

FIG. 3 depicts a perspective view of an embodiment of the disclosed invention using unidirectional airflow.

FIG. 4 depicts a cross-sectional view of an embodiment of the disclosed invention using unidirectional airflow.

FIG. 5 depicts a perspective cross-sectional view of an embodiment of the disclosed invention using a vortex airflow pattern.

FIG. 6 depicts a cross-sectional view of an embodiment of the disclosed invention using a vortex airflow pattern.

FIG. 7 depicts a side view of an embodiment of the disclosed invention having a flow interface stage.

FIG. 8 depicts a perspective view of an embodiment of the disclosed invention having a flow interface stage.

FIG. 9 depicts a cross-sectional view of at least a portion of the flow interface stage of an embodiment of the disclosed invention.

FIG. 10 depicts a perspective cross-sectional view of at least a portion of the flow interface stage of an embodiment of the disclosed invention.

FIG. 11 depicts a perspective cross-sectional view of at least a portion of the flow interface stage of an embodiment of the disclosed invention.

FIG. 12 depicts a perspective exploded view of at least a portion of the flow interface stage of an embodiment of the disclosed invention.

FIG. 13 depicts a cross-sectional view of an embodiment of the disclosed invention.

FIG. 14 depicts a cross-sectional view of an embodiment of the disclosed invention.

The Figures depict embodiments of the disclosed invention for purposes of illustration only. One skilled in the art will readily recognize from the following discussion that alternative embodiments of the structures and methods illustrated herein may be employed without departing from the principles of the invention described herein.

### Definitions

Helmholtz resonator or oscillator means a rigid container that has an open port, such that air flow across the port causes air within the container to resonate or oscillate due to repetitive compression and expansion.

Piezoelectric material means a crystalline material, e.g., quartz (SiO₂), or synthetic ferroelectric ceramics such as lead zirconate titanate, that produces electricity when mechanical stress is applied to the material.

### DESCRIPTION

The disclosed invention relates to devices, systems, and methods for producing electrical power through use of airflow-generated mechanical stress on piezoelectric material.

Disclosed are various embodiments of a piezoelectric airflow power generator comprising a plurality of Helmholtz chambers, each of which contains a plurality of piezoelectric devices capable of generating electric current in response to repetitive air pressure changes. The generator collects air from the environment and directs it in a vortex pattern across the Helmholtz chambers to create resonant air pressure oscillations, which in turn cause the piezoelectric materials to generate electric current.

The disclosed invention will now be described in detail with reference to several embodiments thereof as illustrated in the accompanying Figures. In the following description, numerous specific details are set forth in order to provide a thorough understanding of embodiments of the invention. It will be apparent, however, to one skilled in the art that embodiments may be practiced without some or all of these specific details. In other instances, well known process steps and/or structures have not been described in detail in order to not unnecessarily obscure the disclosed invention. The features and advantages of embodiments may be better understood with reference to the drawings and discussions that follow.

It should be apparent to those skilled in the art that the described embodiments of the disclosed invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the disclosed invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the disclosed invention as the embodiments disclosed herein are merely exemplary.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper,” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under,” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

### Piezoelectric Airflow Power Generator

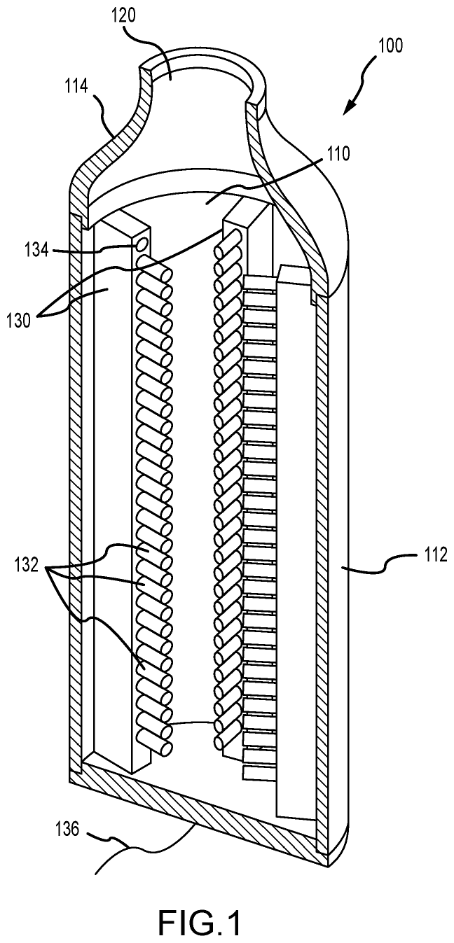

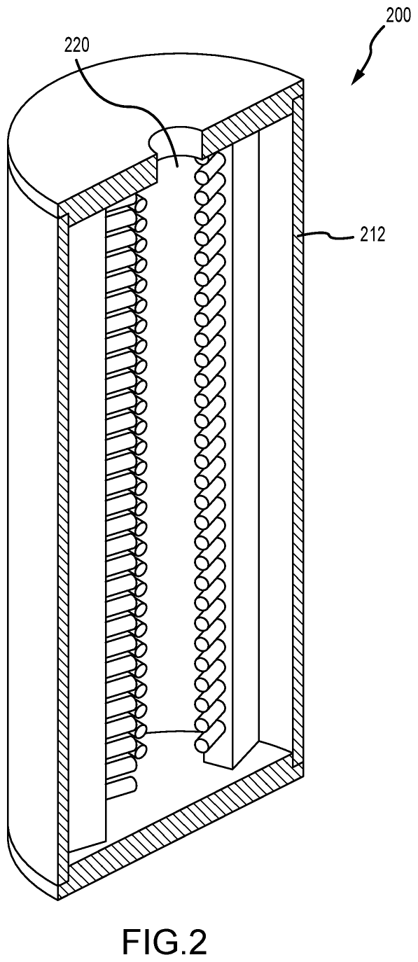

With reference to FIG. 1, an exemplary Helmholtz chamber 100 as used in embodiments of the disclosed invention is depicted. The chamber includes a volume 110 defined by a rigid shell 112, and a port or opening 120 at the top. In the depicted embodiment, the chamber includes a neck 114 in which the port is located. The port may vary in diameter to establish the required Helmholtz resonance for the chamber. Further, the volume of a chamber 100 may vary greatly depending on the planned power output capability. For example, chambers might have a volume of 100 milliliters (mL) for lower output versions, or may be 10 liters (L), 100 L, or larger for higher output versions. A 10 L chamber used as a component of embodiments described herein could achieve an output of 500 watts (W). Within the chamber are a plurality of racks 130 for holding the piezoelectric units 132. The racks may be arranged in different configurations, and each chamber may include different numbers of racks, with the maximum number determined generally by the volume of the chamber, manufacturing complexity, and machining and miniaturization limitations. The racks 132 include a dock 134 for each piezoelectric unit and a wiring harness (not shown) for collecting electric current from each unit and delivering it to a single output carrier 136. Each rack may hold different numbers of piezoelectric units depending on the volume of the chamber and the desired electrical output of the generator. Each piezoelectric unit 132 is comprised of a piezoelectric material, such as a piezoelectric crystal. The piezoelectric units 132 produce alternating current, which is rectified into direct current in parallel or in series as appropriate to charge a battery or capacitor, which then interfaces with a large inverter to provide power output. As shown, the chamber 100 is approximately 30 mL, and contains 6 racks 130, with each rack holding 30 piezoelectric units 132, and capable of generating 5 watts (W) of electricity. With reference to FIG. 2, an alternate configuration of the Helmholtz chamber 200 is depicted, wherein the shell 212 is flat at the top where the port 220 is located.

### Unidirectional Airflow Pattern Generator

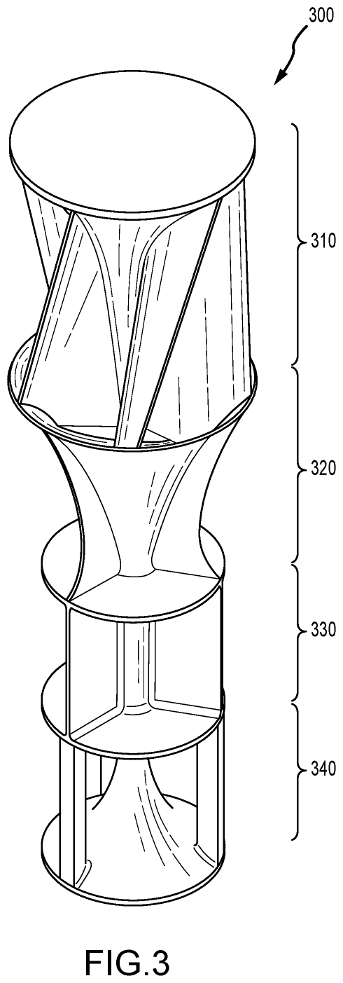

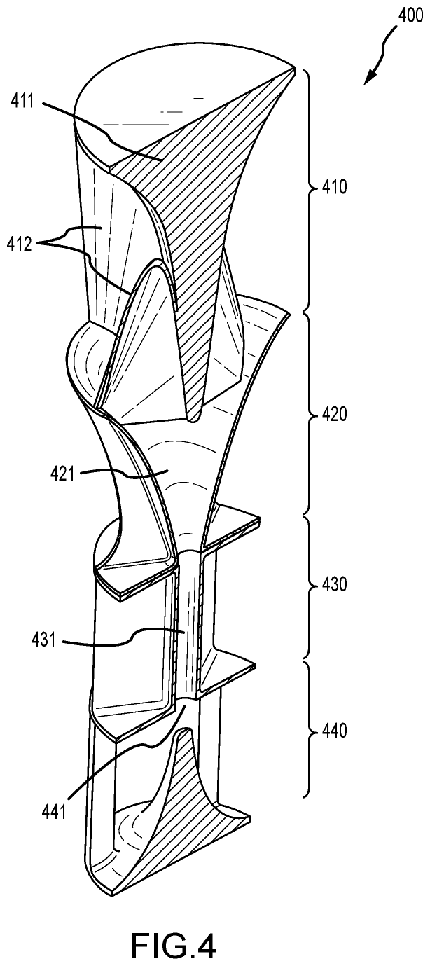

With reference to FIG. 3, an embodiment 300 of the disclosed airflow power generator using a unidirectional airflow pattern is depicted. This embodiment includes four stages: an intake stage 310, a flow treatment stage 320, a flow interface stage 330, and an exhaust stage 340. With reference to FIG. 4, the intake stage 410 is configured to route wind or airflow into the device from any direction. The core of the inlet 411 is an inverted pyramidal or conical shape and is surrounded by a set of baffles or blades 412 that extend from the core to the outer edge of the generator. The size of the intake stage determines the volume of airflow that can be routed into the generator. Embodiments described herein using a multi-directional intake stage are best suited for collecting wind energy from the ambient environment. However, other uses and configurations are possible and contemplated. For example, some embodiments may be configured to harvest energy from an energy storage device, such as a container holding pressurized air. As the pressurized container is vented out of an exhaust port, the generator could convert the resulting airflow into electrical power. In such embodiments, the intake stage is configured to collect airflow from the exhaust port and route it into the flow treatment stage. Other applications where the generator would be exposed to airflow having a prevailing direction, such as a mounting location at the mouth of a cave, in a canyon, in an alley, etc., or mounted on a vehicle, such as an automobile or airplane, may be more efficiently harvested by intake stages configured to collect airflow from the prevailing airflow direction.

The flow treatment stage 420 includes a venturi inlet 421 that features a gradually reducing cross sectional area that accelerates airflow as it moves through the inlet. By accelerating the incoming airflow, the generator is able to use lower incoming air speeds to produce larger pressure oscillations within the Helmholtz chambers. The flow interface stage 430 includes a flow interface chamber 431 that directs accelerated airflow from the venturi inlet 421 across a plurality of Helmholtz chambers (not shown). In this embodiment, the Helmholtz chambers would be arranged radially out from the flow interface chamber 431, and each would have a port opening onto the chamber. As accelerated airflow moves past the ports, Helmholtz oscillations are created in the chambers, and electrical current is produced. The exhaust stage 440 includes a venturi outlet 441, which gradually expands the flow area of the airflow as it exits the generator. Gradual deceleration of the airflow minimizes turbulence and back pressure within the generator, particularly within the flow interface chamber 431. In some embodiments, the outlet includes a venturi pump (not shown) that creates a vacuum at the outlet. The resulting vacuum boosts airflow out of the generator so that airflow is both pushed into the device at the inlet stage, and pulled out of the device at the exhaust stage for overall improved airflow through the generator. In some embodiments, the exhaust stage is combined with the flow interface stage.

### Vortex Pattern Generator

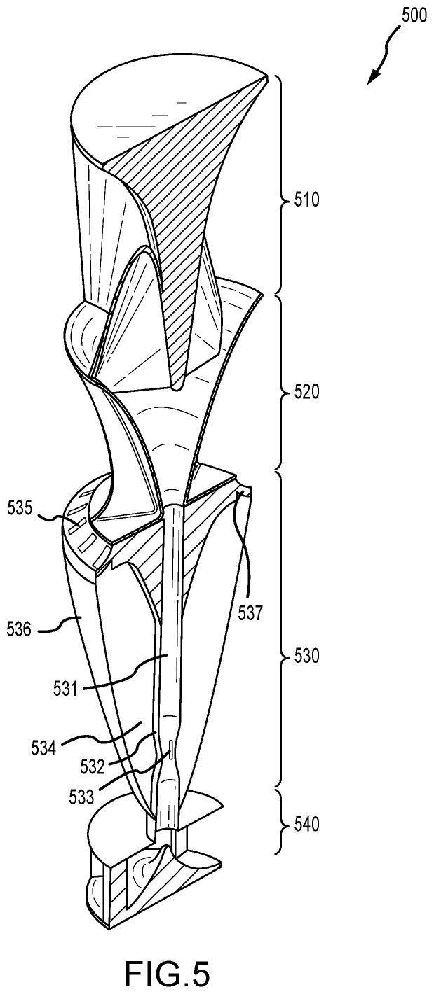

With reference to FIG. 5, an embodiment of the disclosed invention that creates vortex airflow across a plurality of Helmholtz chambers is depicted. In this embodiment, the generator includes a modified flow interface stage 530. The generator collects multi-directional airflow at the intake stage 510 that is funneled into the flow treatment stage 520, creating a high-speed centerline airflow 531 into the flow interface stage 530. The airflow 531 is directed into a venturi section 532 having a narrow cross section that creates a low-pressure zone. The venturi section further includes a plurality of inlets 533 that draw air out of a vortex chamber 534, creating a low-pressure zone within the vortex chamber. The vortex chamber further includes a plurality of intake slots 535 with angled blades 537 arranged in a ring shape around the centerline. As the centerline airflow 531 creates a low-pressure area in the vortex chamber 534, air from outside the generator is drawn into the vortex chamber through the intakes and is directed by the angled blades 537 into a vortex pattern across the inner surface of the vortex chamber shell 536. The vortex chamber shell includes a plurality of ports (not shown) leading to Helmholtz chambers (not shown) arranged radially out from the vortex chamber shell. Airflow circling the vortex chamber is primarily directed into a laminar flow, which is preferred for creating resonance within the Helmholtz chambers. Some turbulent airflow may still be present however, and may be remediated by use of surface treatments to improve airflow across the ports. In some embodiments, the vortex chamber is partially filled from the central core toward the shell 536 to improve efficiency. As with the unidirectional embodiment, an exhaust stage 540 aids the removal of air out of the device through use of a venturi outlet or other suitable means.

Another embodiment of the vortex pattern generator develops vortex airflow in the vortex chamber by forming the flow treatment stage 520 into a spiral shape (not shown) to direct airflow into a laminar flow across the inner surface of the vortex chamber shell 536. In another embodiment, the flow treatment stage 520 includes an inverted central cone that directs airflow toward the outer edge of the vortex chamber 534. From there, airflow is directed through a ring of angled blades (not shown) creating a vortex pattern around the vortex chamber shell.

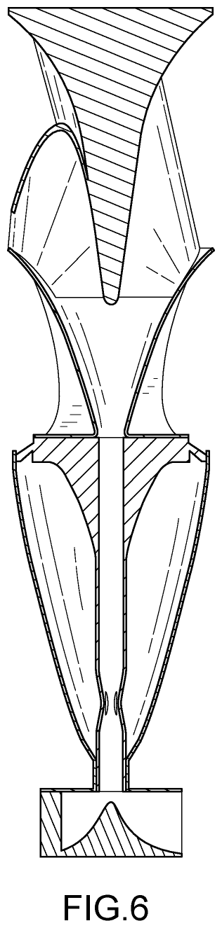

As compared to the unidirectional embodiment depicted in FIGS. 3 and 4, the vortex pattern device depicted in FIGS. 5 and 6 displays the advantages of using a vortex airflow pattern to harvest airflow energy. First, the surface area having sufficient airflow speed to cause Helmholtz oscillations is greater in the vortex pattern embodiment. Assuming it has a cross section optimized for maintaining a high velocity airflow through the device for a maximum distance, the flow interface chamber of the unidirectional embodiment, see FIG. 4, item 431, will have a given maximum surface area based on the amount of air the intake stage can capture and direct through the chamber. As is also apparent, much of the air flowing through the interface chamber 431 does not interact with the Helmholtz chambers at all. With the exception of a thin layer of air along the outside edge that actually passes across Helmholtz chamber ports, most of the air flowing through the device passes straight through without interacting with the piezoelectric units. However, the vortex pattern embodiment, using the same intake stage, is able to generate a thin laminar flow of air sufficient to induce Helmholtz oscillations over the larger surface area of the vortex chamber shell, see FIG. 5, item 536. The vortex pattern embodiment can therefore accommodate more Helmholtz chambers than the unidirectional generator. Further, airflow brought into the vortex chamber makes a number of passes around the vortex chamber 537 before losing energy and passing out of the device. The vortex pattern embodiment therefore uses the same airflow energy to activate more piezoelectric units for a longer period of time, and as a result, harvests airflow energy much more efficiently than the unidirectional embodiment.

### Horizontal Vortex Pattern Generator

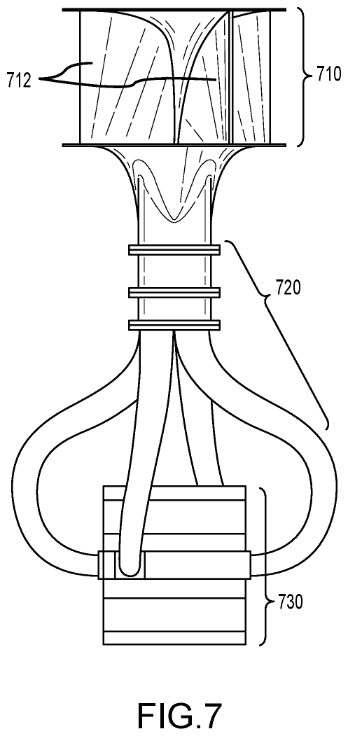

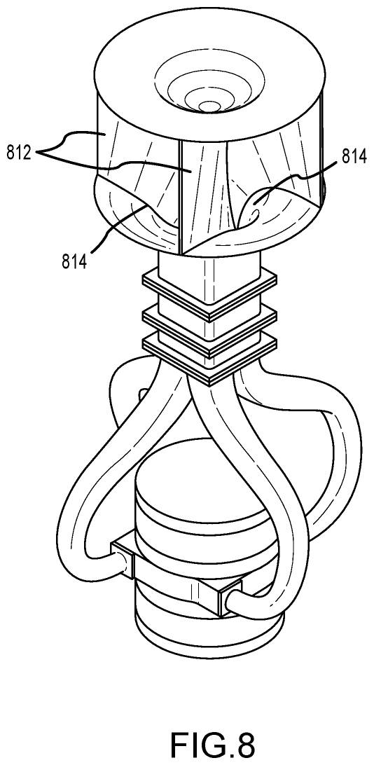

FIGS. 7-14 depict a preferred embodiment of the disclosed invention. With reference to FIG. 7, the embodiment includes an intake stage 710, a flow treatment stage 720, and a flow interface stage 730. As with prior embodiments, the intake stage includes a set of blades 712 configured to collect ambient air from multiple directions and direct the airflow into the generator. With reference to FIG. 8, the blades 812 direct airflow into the generator through a set of intakes 814.

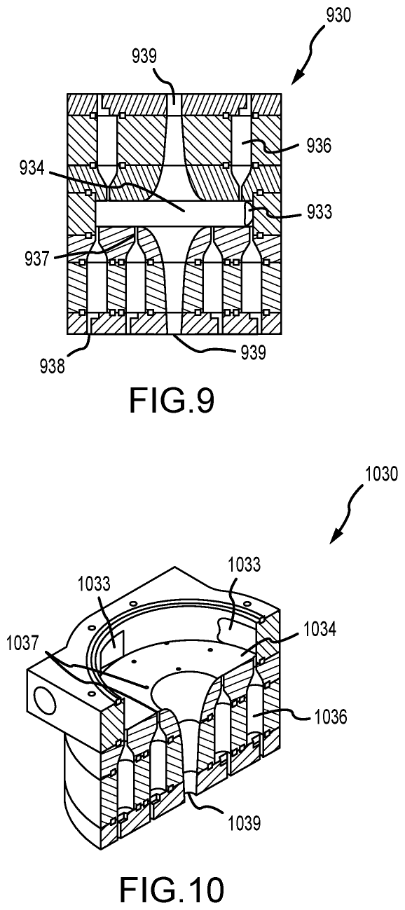

With reference to FIG. 9, a cross-sectional view of the flow interface stage FIG. 7, item 730, is depicted. The flow interface stage 930 includes a vortex chamber 934 having set of vortex outlets 933 (one is shown). Air is directed through the vortex outlets 933 so that it creates a laminar airflow around the vortex chamber and across a plurality of ports 937. Each port 937 opens into a separate Helmholtz chamber 936 that contains a plurality of piezoelectric units (not shown). The Helmholtz chambers each have an electrical outlet 938 for electrical connections to carry generated electrical power out. Generated electrical power is routed from each Helmholtz chamber 936 to a power processor (not shown) where it is further processed for device output. The power processor receives alternating current (AC) from the Helmholtz chambers, and first rectifies it into direct current (DC) by combining the various inputs in parallel or in series, as appropriate. The resulting DC is used to charge a rechargeable battery or capacitor where it is stored before being converted back into AC by an inverter. The power processor then supplies the AC out of the device as generated power output. In the depicted embodiment, Helmholtz chambers 936 are located above and below the vortex chamber, with ports located in the floor and ceiling of the chamber respectively. In other embodiments (not shown), there are Helmholtz chambers configured radially out from the vortex chamber, each with a port opening in the side wall of the vortex chamber. Air exits the vortex chamber 934 through a pair of opposing venturi exhaust ports 939 arranged axially at the center of the vortex chamber.

With reference to FIG. 10 a perspective view of the lower portion of the interface stage 1030 is depicted. This view shows the vortex chamber 1034 with a plurality of ports 1037 located in the floor of the vortex chamber, each of which feeds into a separate Helmholtz chamber 1036. The vortex chamber 1034 also has two or more vortex outlets 1033 for feeding air into the vortex chamber 1034 horizontally, i.e., at a 90-degree angle to the chamber. Embodiments of the generator using vortex outlets may have between 2 and 6 vortex outlets, with preferred embodiments having 3 or 4 vortex outlets. The upper range of vortex outlets tends to produce less turbulent air within the vortex chamber, but are also more complex to manufacture.

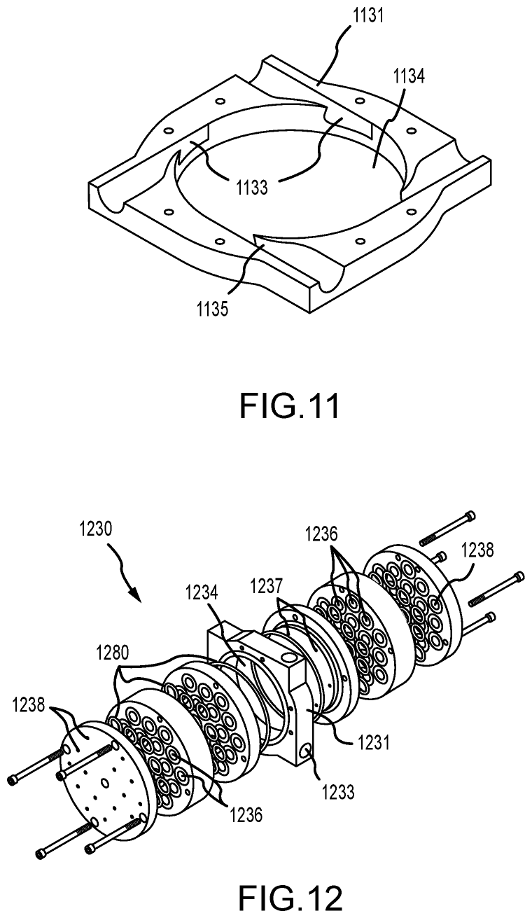

With reference to FIG. 11, a section 1131 of the interface stage 1030 comprising the side walls of the vortex chamber 1134 is depicted. Air is routed into the vortex chamber through vortex outlets 1133 (four are shown). Each vortex outlet includes a venturi nozzle 1135 upstream of the vortex chamber 1134 that causes airflow to increase in speed as it enters the vortex chamber. As air feeds into the chamber through the outlets, it moves in a clockwise direction around the chamber and across the plurality of Helmholtz chambers (not shown).

With reference to FIG. 12, an exploded view of the interface stage 1230 is depicted. In this embodiment, the interface stage is comprised of a stack of layers. (seven are shown) each of which is machined to incorporate a portion of the interface stage. The interface stage may be constructed in layers to improve manufacturability and scalability. The layer 1231 forming the sidewalls of the vortex chamber 1234 includes the vortex outlets 1233. In the next lower section 1220, a number of ports 1237 in the floor of the vortex chamber are visible, each of which opens into a Helmholtz chamber 1236. Also visible are the electrical outlet ports 1238 allowing wires to carry generated electrical power out from the piezoelectric units (not shown) for processing. A plurality of O-rings 1280 is included to render the interfaces between layers airtight, including O-rings to seal the Helmholtz chambers 1236.

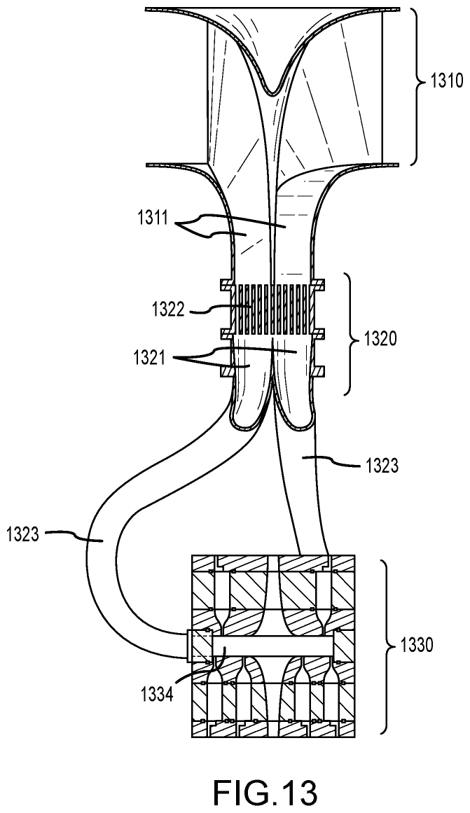

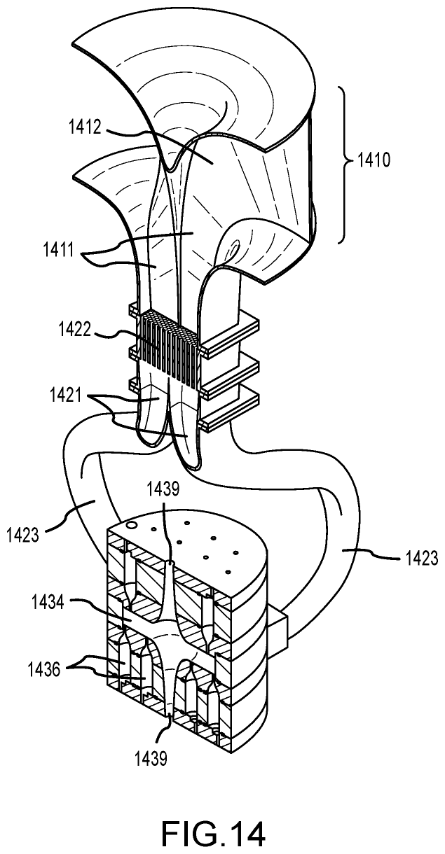

With reference to FIG. 13, a cross section of the preferred embodiment is depicted. In this view, detail of the flow treatment stage 1320 is shown. Airflow 1311 is routed from the intake stage 1310 into a flow guide 1322. The flow guide is comprised of a plurality of tubes, which may have circular or hexagonal cross sections, or another suitable shape. The flow guide takes turbulent airflow 1311 and converts it to laminar air flow 1321. The laminar air flow 1321 is routed into a set of channels 1323. The channels direct the laminar air flow 1321 away from the centerline of the device and deliver it to the vortex chamber 1334 at a 90-degree angle, where it enters the vortex chamber through the vortex outlets to create the vortex airflow pattern within the chamber 1334. FIG. 14 depicts an alternate view of the preferred embodiment. In this view, the blades 1412 collect ambient air as it blows past the intake, and direct airflow 1411 into the flow guide 1422. Some embodiments have an intake configured to receive airflow from a pressurized tank or airflow source having a prevailing direction. Laminar airflow 1421 moves into the channels 1423 and is delivered to the vortex chamber 1434 where it creates laminar airflow in a vortex pattern. As air moves around the vortex chamber 1434, it flows across a plurality of ports (not shown) located in the ceiling and floor of the vortex chamber where the air flow causes Helmholtz resonance within a plurality of Helmholtz chambers 1436. Air pressure oscillations within the Helmholtz chambers 1436 cause the piezoelectric units (not shown) to generate electricity. Air then exits the generator through a set of opposing venturi outlets 1439.

Other embodiments of airflow power generators using vortex pattern airflows are possible and contemplated. For example, with further reference to FIG. 13, rather than routing airflow 1321 into airflow channels 1323, the airflow would be routed into a ring of intake slots and angled blades, similar to that used in previous embodiments. See FIG. 5, item 537. As airflow exits the flow guide, it would pass an inverted conical or pyramidal surface that would route the air out to the ring of angled blades. As the air passes through the intake slots, the blades would impart a rotational flow to the air as it enters the vortex chamber 1334. In such embodiments, the top portion of the interface stage 1330 would be further modified by removing the outer Helmholtz chambers to make room for the ring of angled blades. The upper exhaust port and the vortex outlets would also be removed.

In another embodiment, with further reference to FIG. 14, rather than routing airflow 1421 into airflow channels 1423, it would be passed into the top exhaust outlet 1439, which acts as a venturi pump to accelerate the airflow through the center of the vortex chamber 1434 and directly out the lower exhaust port 1439. Directing airflow in this way creates a vacuum in the vortex chamber. The vortex outlets of the original configuration are replaced with angled intake slots cut in the sidewall of the vortex chamber. The vacuum draws outside air into the vortex chamber 1434 through the slots, which establishes a vortex airflow pattern in the chamber, where it flows over the Helmholtz chambers, thereby creating electrical power.

While this invention has been described in terms of several embodiments, there are alterations, modifications, permutations, and substitute equivalents, which fall within the scope of this invention. Although subsection titles have been provided to aid in the description of the invention, these titles are merely illustrative and are not intended to limit the scope of the present invention. In addition, where claim limitations have been identified, for example, by a numeral or letter, they are not intended to imply any specific sequence. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

This has been a description of the disclosed invention along with a preferred method of practicing the invention, however the scope of the invention ought to be determined by the appended claims.

What is claimed is:

1. A power generator, comprising:
an intake stage;
a flow treatment stage;
a flow interface stage; and
a power processor,
wherein the intake stage comprises a plurality of blades oriented to collect a flow of air from multiple directions and direct the flow of air to the flow treatment stage,
wherein the flow treatment stage modifies the flow of air and directs a modified flow of air into the flow interface stage,
wherein the flow interface stage includes a flow interface chamber, one or more exhaust outlets, and a plurality of Helmholtz chambers,
wherein each of the plurality of Helmholtz chambers includes a port, a plurality of piezoelectric units, and a connector for delivering electrical power to the power processor.

2. The power generator of claim 1, wherein:
the flow treatment stage includes one of the following: a venturi inlet, a spiral inlet, or an inlet with a central inverted cone for pushing airflow to an outer edge of the flow interface chamber.

3. The power generator of claim 1, wherein:
the flow treatment stage includes a flow guide comprised of a set of tubes, and two or more channels for delivering airflow to the flow interface chamber at a 90 degree angle, each of the two or more channels further comprising a venturi nozzle.

4. The power generator of claim 2, wherein:
the flow interface chamber further comprises a venturi section, a vortex chamber, and a plurality of intake slots with angled blades, and
wherein each of the plurality of Helmholtz chambers has a port that opens onto the vortex chamber.

5. The power generator of claim 3, wherein:
the flow interface chamber includes two or more vortex outlets, each of the two or more vortex outlets corresponding to one of the two or more channels;
the Helmholtz chambers are divided into a top set and a bottom set, wherein each Helmholtz chamber in the top set includes a port that opens onto a ceiling of the vortex chamber, and each Helmholtz chamber in the bottom set includes a port that opens onto a floor of the vortex chamber; and
the one or more exhaust outlets is a pair of venturi outlets located on a centerline of the flow interface chamber.

6. The power generator of claim 3, wherein the flow interface stage is comprised of layers.

7. A generator, comprising:
a plurality of blades for collecting a flow of air and directing the flow of air into a flow treatment stage;
a flow interface chamber;
a plurality of Helmholtz chambers, each of the plurality of Helmholtz chambers including a port, a plurality of piezoelectric units, and an electrical connection;
one or more exhaust outlets; and
a power processor.

8. The power generator of claim 7, wherein:
the flow treatment stage includes one of the following: a venturi inlet, a spiral inlet, or an inlet with an inverted central cone for pushing airflow to an outer edge of the flow interface chamber.

9. The power generator of claim 7, wherein:
the flow treatment stage includes a flow guide comprised of a set of tubes, and two or more channels for delivering airflow to the flow interface chamber at a 90 degree angle, each of the two or more channels further comprising a venturi nozzle.

10. The power generator of claim 8, wherein:
the flow interface chamber further comprises a venturi section, a vortex chamber, and a plurality of intake slots with angled blades, and
wherein each of the plurality of Helmholtz chambers has a port that opens onto the vortex chamber.

11. The power generator of claim 9, wherein:
the flow interface chamber includes two or more vortex outlets, each of the two or more vortex outlets corresponding to one of the two or more channels;
the Helmholtz chambers are divided into a top set and a bottom set, wherein each Helmholtz chamber in the top set includes a port that opens onto a ceiling of the vortex chamber, and each Helmholtz chamber in the bottom set includes a port that opens onto a floor of the vortex chamber; and
the one or more exhaust outlets is a pair of venturi outlets located on a centerline of the flow interface chamber.

12. The power generator of claim 9, wherein the flow interface stage is comprised of layers.

13. A method of using airflow to generate electrical power, the method comprising:
capturing energy from an environment as a flow of air;
directing the flow of air through a flow treatment stage;
directing a modified flow of air from the flow treatment stage into a flow interface stage;
using the modified flow of air to establish air pressure oscillations within a plurality of Helmholtz chambers located in the flow interface stage;
using the air pressure oscillations within each of the plurality of Helmholtz chambers to cause a plurality of piezoelectric units to generate electrical current;
passing a flow of exhaust air out of the flow interface stage through one or more exhaust outlets; and
processing the electrical current for use as a power source.

14. The method of claim 13, further comprising:
using the modified flow of air to generate a vortex airflow within a flow interface chamber; and
directing the vortex airflow across a plurality of ports, wherein each of the plurality of ports corresponds to a Helmholtz chamber, and wherein the vortex airflow flows across at least one port two or more times.

15. The method of claim 13, further comprising:
creating a modified flow of air within the flow treatment stage by one of the following:
passing the flow of air though a venturi inlet, passing the flow of air through a spiral inlet, or passing the flow of air through an inlet with an inverted central cone.

16. The method of claim 14, further comprising:
creating a modified flow of air within the flow treatment stage by passing the flow of air through a flow guide, and from the flow guide into two or more channels for delivering the modified flow of air to a flow interface chamber.

17. The method of claim 14, further comprising:
directing the modified flow of air through a venturi section to create a vacuum in the flow interface chamber; and
drawing air into the flow interface chamber to generate the vortex airflow.

18. The method of claim 16, wherein:
the one or more exhaust outlets is a pair of venturi outlets located on a centerline of the flow interface chamber.

19. The method of claim 13, wherein the modified flow of air is a laminar flow.
